(19) United States
(12) Patent Application Publication
(10) Pub. No.: US 2026/0074247 A1
(43) Pub. Date: Mar. 12, 2026

(54) FUEL CELL ADAPTIVE PURGE DRAIN VALVE CONTROL

(71) Applicant: FORD GLOBAL TECHNOLOGIES, LLC, Dearborn, MI (US)

(72) Inventors: Michiel J. Van Nieuwstadt, Ann Arbor, MI (US); Craig Winfield Peterson, West Bloomfield, MI (US); Hao Wang, Ann Arbor, MI (US); Zeng Qiu, Ann Arbor, MI (US); Ming Cheng, Northville, MI (US)

(21) Appl. No.: 18/829,354

(22) Filed: Sep. 10, 2024

(51) Int. Cl. H01M 8/04119; B60L 58/30; H01M 8/0438; H01M 8/04746; H01M 8/04828; H01M 8/04992

(52) U.S. Cl. CPC H01M 8/04179; H01M 8/04432; H01M 8/04761; H01M 8/04843; H01M 8/04992; B60L 58/30; H01M 2250/20

(57) ABSTRACT

A fuel cell system for a vehicle includes an anode manifold, a drain valve, and a controller. The controller adjusts the duration for which the drain valve remains open or closed based on changes in the anode pressure slope associated with the valve's operation. The system, for example, increases the duration that the drain valve remains closed in response to a change in the anode pressure slope following an opening command and adjusts the duration that the valve remains open based on changes in the slope resulting from a closing command.

### STATEMENT REGARDING FEDERALLY SPONSORED RESEARCH OR DEVELOPMENT

This invention was made with Government support under Contract No. DE-EE0009858 awarded by The Department of Energy. The Government has certain rights in the invention.

### TECHNICAL FIELD

This disclosure relates to fuel cell operation.

### BACKGROUND

Fuel cells are electrochemical devices that convert the chemical energy in hydrogen into electrical energy through a reaction with oxygen, producing water and heat as byproducts. In a typical fuel cell, hydrogen gas is introduced at the anode, where a catalyst splits it into protons and electrons. The protons move through an electrolyte membrane to the cathode, while the electrons travel through an external circuit, generating electricity. At the cathode, the protons, electrons, and oxygen from the air combine to form water. Fuel cells are often stacked together to provide the power required for various applications, including vehicles. In fuel cell vehicles, this stack supplies electricity to power the electric motor.

Fuel cell vehicles incorporate several components to manage the hydrogen supply, maintain operating conditions, and achieve energy conversion. The fuel cell stack is the core of the vehicle, requiring control of hydrogen pressure and flow. The anode manifold directs hydrogen into the fuel cell, aided by a series of sensors and actuators.

### SUMMARY

A vehicle is equipped with a fuel cell system that includes an anode manifold, a drain valve, and a controller. The controller adjusts the duration for which the drain valve remains closed, depending on the anode pressure slope associated with the anode manifold.

A method is described for operating a fuel cell system, in which the duration that a drain valve remains closed is increased in response to a change in the anode pressure slope that occurs following an opening command for the drain valve.

A fuel cell system features a fuel cell stack, a drain valve, and a controller. The controller adjusts the duration for which the drain valve remains open, based on changes in the anode pressure slope that result from a closing command for the valve.

### BRIEF DESCRIPTION OF THE DRAWINGS

FIGS. 1A-1C, 2A-2C, and 3A-3C are plots of anode pressure profile, drain valve command profile, and injector current, respectively, under various conditions.

FIG. 4 is flowchart of an algorithm for controlling purge duration based on anode pressure slope.

FIG. 5A-5C are plots showing how the purge close duration and purge open duration change responsive to anode pressure slope.

FIG. 6 is a block diagram of a vehicle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In many fuel cell systems, a drain valve (DV) is employed to remove non-reactive species, primarily water (in either liquid or vapor form) and nitrogen gas (N₂), from the anode manifold. This purging maintains an adequate supply of reactants for power generation and prevents flooding of the membrane. The accumulation of these non-reactive species can hinder the availability of hydrogen (H₂), leading to unstable operation at high power levels and potential membrane flooding, which may block reactants from reaching the catalyst.

When the DV is opened, all species in the manifold are expelled; however, only the hydrogen is replenished via the H₂ injector. This combined action of purging and H₂ injection results in an increased hydrogen concentration. If purging is infrequent, the H₂ concentration decreases, compromising the stability of the fuel cell system at high power outputs. Conversely, excessive purging can lead to unnecessary loss of H₂, which could otherwise be used for power generation, thereby reducing the overall efficiency of the system.

The DV is designed so that liquid water is removed first, followed by the expulsion of gaseous species, including water vapor, nitrogen, and hydrogen. The removal of liquid water has a minimal impact on anode pressure, while the expulsion of gaseous species causes a pressure drop that is approximately linear over time. The transition from liquid to gas removal can be detected by observing a change in the slope of the anode pressure signal.

There are four scenarios regarding the behavior of the DV during its operation:
1. If the DV opens during an H₂ injection and there is no change in the slope, this suggests that water is blocking the DV passage, preventing gas from exiting. This behavior is typical at lower temperatures. If there is no water blockage, the slope will decrease as gas is expelled, a condition more common at higher temperatures when water is primarily in vapor form.
2. If the DV closes during an H₂ injection and the slope remains unchanged, water is likely blocking the DV passage. Without water obstruction, the slope will increase as gas is no longer exiting through the DV.
3. If the DV opens when no H₂ injection is occurring and the slope does not change, water is still blocking the DV passage. Without water obstruction, the slope will become more negative as gas exits.
4. If the DV closes when there is no H₂ injection and the slope remains the same, this indicates ongoing water blockage. Without the blockage, the slope will decrease less sharply as gas no longer exits.

The following figures have three windows. The first shows the anode pressure profile. The anode pressure roughly follows a sawtooth shape where the rising slope is caused by the injector adding H₂, and the falling slope is caused by hydrogen atoms migrating through the membrane. The second window is the DV command profile. The third window is the injector current, exhibiting a peak and hold pattern.

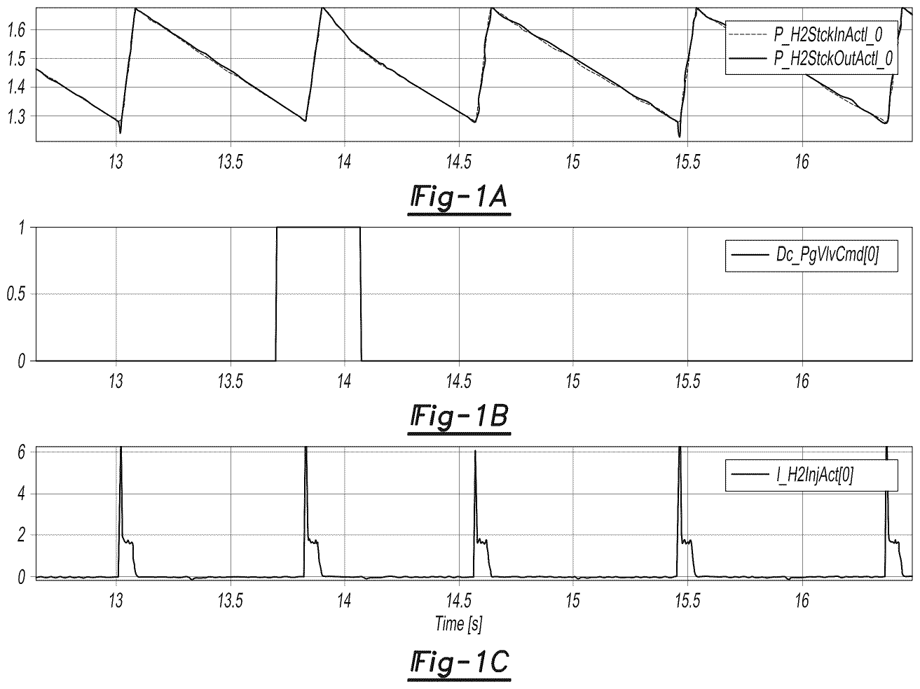

Referring to FIGS. 1A-1C, the DV closing event at t=14.2 s causes an increase in anode pressure slope, indicating that all water was evacuated, and gas was exiting through the valve.

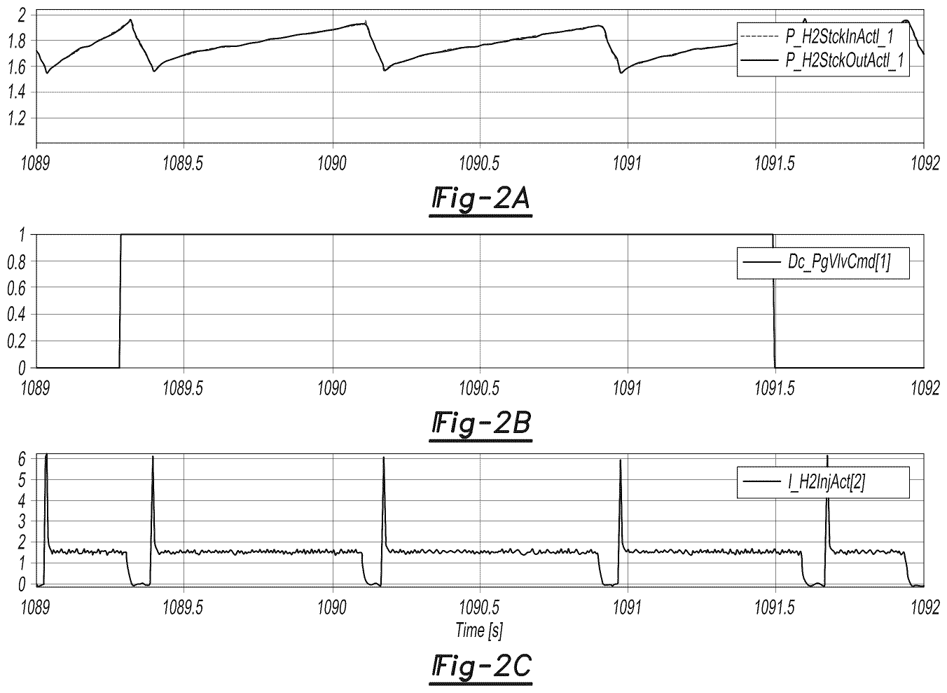

Referring to FIGS. 2A-2C, the DV closing event at t=109.5 s during an injection event causes an increase in anode pressure slope, indicating that all water was evacuated, and gas was exiting through the valve. In this case the increase happens during an injection event, so the slope goes from positive to more positive.

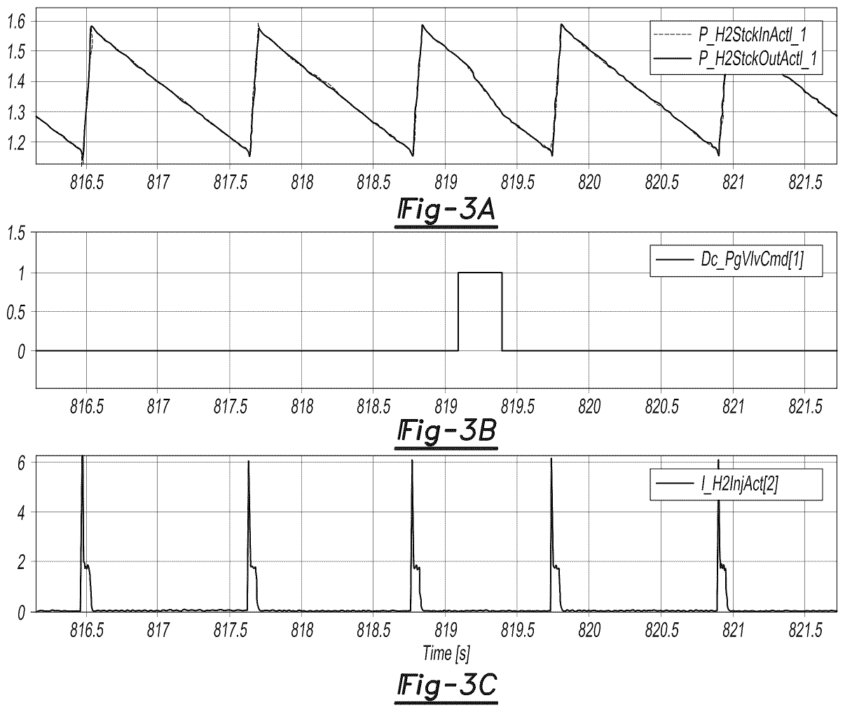

Referring to FIGS. 3A-3C, the DV opening/closing causes a decrease/increase in anode pressure slope, indicating that there is no water in the DV during this entire DV event.

Optimal operation is characterized by no slope change when the DV opens (indicating water is present and being evacuated) and a positive slope change when the DV closes (signifying that all water has been removed and gas evacuation has ceased).

Modeling or measuring the amount of liquid water in the anode manifold is challenging because it does not affect the concentration of gaseous species. Additionally, installing a physical sensor to detect water presence is undesirable due to constraints and reliability, in particular contamination from washout from the stack. Therefore, utilizing the slope change in anode pressure as an adaptive control mechanism for the DV's purge schedule is of interest.

A nominal purge schedule is initially mapped to achieve optimal performance; however, due to factors such as changes in the fuel cell stack over its lifespan and variability in components like the injector, membrane, and DV, this initial schedule may lose its effectiveness over time. Therefore, the purge schedule should be periodically adapted to maintain performance throughout the fuel cell's life.

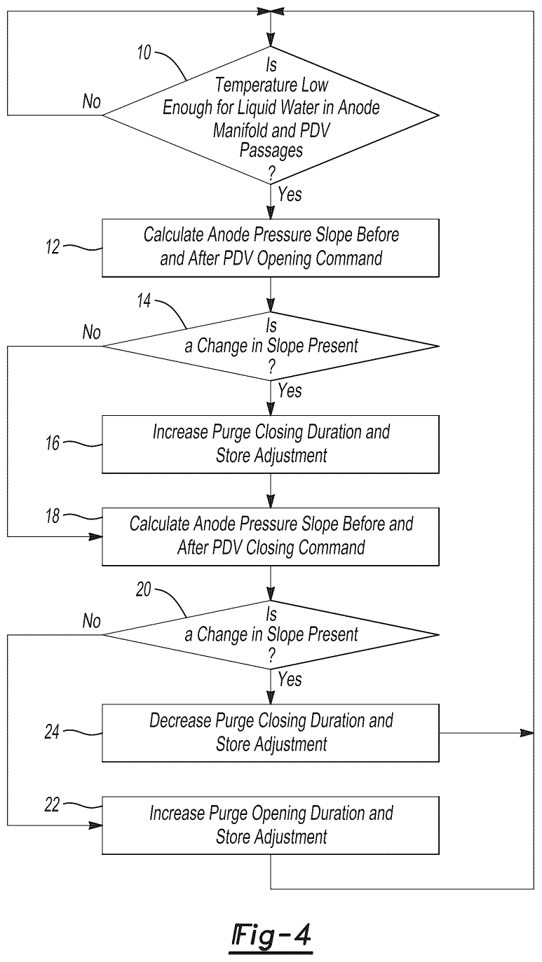

Referring to FIG. 4, the adaptation process begins at operation 10, where the system checks if the temperature in the anode manifold and DV passages is low enough to expect liquid water formation. If the temperature exceeds a predefined threshold, the system will wait for it to drop below this threshold before proceeding. Once the temperature is sufficiently low, the process advances to operation 12, which involves calculating the slope of the anode pressure both before and after issuing the DV opening command. For the slope calculation to be accurate, the DV opening command should not be issued too close to a change in the injector command, as this could affect the calculation. If no significant change in slope is observed at operation 14, the algorithm proceeds to operation 18. If a significant change in slope is observed, it indicates that there was minimal water in the anode, which allows for an increase in the purge closing duration at operation 16. This adjustment can be recorded several ways: in a table based on operating conditions (such as current and stack temperature), as an additive correction value applicable over a broader operating range, or as a multiplicative correction factor also applicable over a wider range. These adjustments can be stored in non-volatile memory to continuously adapt and refine the purge schedule.

After making the adjustment at operation 16, the process moves to operation 18, where the anode pressure slope is recalculated, this time before and after the DV closing command. Similar to the opening command, the closing command should not occur too close to a change in the injector command to ensure the accuracy of the slope calculation. If no change in slope is detected at operation 20, it suggests that the purge opening duration was insufficient to evacuate all the water, necessitating an increase in the duration at operation 22. Conversely, if a change in slope is observed and other factors such as power output, hydrogen concentration, and stack efficiency are within acceptable limits, the purge opening duration can be decreased at operation 24. These adjustments can be similarly stored in non-volatile memory, using tables, additive correction values, or multiplicative correction factors.

Finally, the algorithm loops back to operation 10, continuing the cycle of temperature checks and slope calculations. The magnitude of the corrections made during operations 16, 22, 24 should be based on the operating conditions and whether the slope calculation occurs during an H injection event. The slope of the anode pressure can be determined using a recursive least squares algorithm or by averaging a few pressure points at the beginning and end of the interval over which the slope is calculated, typically ranging from 0.1 to 1 second.

The algorithm described above can be extended to diagnose a stuck DV. If, at operation 20, there is no change in the anode pressure slope, and the positive correction factor exceeds a significant threshold or value, this suggests that the DV may be stuck either closed or open. In such a case, a fault indication could be displayed on the vehicle's dashboard to alert the driver to the issue.

To calculate the anode pressure slope before and after the DV opening and closing commands, a derivative-based algorithm similar to the following may be used.

The first step in the algorithm involves computing the first-order derivative of the anode pressure reported from a suitable pressure sensor, which represents the rate of change of pressure over time. This can be done using a ring buffer structure that stores pressure values. The buffer size is typically larger than necessary, allowing flexibility in selecting the subset of values over which the derivative is calculated. For example, if the buffer size is set to 50 and the derivative is computed over 40 samples, this allows for a high-resolution data collection. The sampling time is usually set to a small value, such as 0.001 seconds, to ensure detailed data collection. The first-order derivative is then calculated over the selected subset, producing a rate of change of anode pressure. This derivative is filtered using a first-order low-pass filter with a time constant of around 0.1 seconds, which smooths the derivative, reducing noise. To ensure accuracy, it is helpful to avoid calculating the derivative during intervals where abrupt changes occur, such as during changes in the injector commands. The low-pass filter is reset to zero when a change in the injector command is detected.

Before the DV opens, the anode pressure slope is captured on the rising edge of the DV command. This value, referred to as pan_der_ako_rising, represents the last valid anode pressure slope before the DV opens and serves as a reference for comparing the pressure slope during and after the DV operation. The anode pressure slope during the DV opening phase is calculated under specific conditions. This slope, referred to as pan_der_ako_open, is determined during the period when the DV is open, provided that a sufficient amount of time, typically more than 0.1 seconds, has passed since the last injector command change. This approach allows the slope to reflect the true effects of the DV opening without interference from recent injector actions. Since the derivative is sensitive to recent changes, pan_der_ako_open is typically not available immediately after the DV opens but rather during a stable period within the DV open phase.

The algorithm also computes the anode pressure slope after the DV closes, although this value is not immediately used in the control algorithm. This slope, denoted as pan_der_ako_falling, is captured after the falling edge of the DV command and after the last injector change. While this value is not currently utilized, it can be computed to enhance the robustness of the algorithm for potential future adjustments. All the captured slopes (pan_der_ako_rising, pan_der_ako_open, and pan_der_ako_falling) are taken when the injector is closed, which results in these slopes being negative, as expected in this context because pressure naturally decreases when the injector is not actively injecting.

A drop in the anode pressure slope during the DV open phase indicates successful purging. This drop is detected if pan_der_ako_open is less than pan_der_ako_rising by a predefined amount, typically if the current derivative p_anode_derflt is less than 1.2×pan_der_ako_rising, where p_anode_derflt is the filtered pressure derivative. This condition is checked only during the DV open phase to confirm that the DV is indeed open when the drop in pressure slope is detected. If the condition holds, a flag slopedn_with_ako_open is set, confirming successful water evacuation during the purge.

After the DV closes, an increase in the anode pressure slope, although still negative, indicates that the pressure is stabilizing. This increase is detected if p_anode_derflt, the current derivative, is greater than pan_der_ako_open by a predefined amount, typically if it is greater than 0.8×pan_der_ako_open. This check occurs sometime after the falling edge of the DV command and before the next injector opening, allowing the derivative to reflect the stable condition after the DV has closed. If this condition holds, a flag slopeup_with_ako_closed is set, indicating that the system is returning to a stable state post-purge.

Another potential technique for calculating the anode pressure slope involves the use of a linear regression approach over a sliding window of pressure data points. In this method, a window of time, say 0.1 to 1 second, is selected during which pressure data is continuously collected at a fixed sampling rate. Instead of calculating a simple first-order derivative, this approach fits a linear regression model to the data points within the sliding window. The slope of the best-fit line obtained from the regression model represents the rate of change of the anode pressure.

To implement this technique, the system continuously gathers pressure data from appropriate sensors and stores it in a buffer that holds the values corresponding to the defined time window. As new data points are collected, older ones are discarded to maintain the window size, allowing the slope calculation to reflect the most recent pressure changes. The linear regression is then applied to these buffered data points, providing an estimate of the pressure slope by considering the trend over multiple points rather than relying on the difference between just two consecutive points.

This regression-based approach has the possible advantage of smoothing out noise and short-term fluctuations that might otherwise affect the accuracy of a simple derivative calculation. It also reduces the effect of transient disturbances, such as injector command changes or brief sensor anomalies, by averaging their effects across the data set. The resulting slope may be less sensitive to outliers and can provide a more stable and reliable measure of the anode pressure trend.

Like any method, this technique requires calibration, particularly in selecting the appropriate window size. Additionally, the system should account for the time delay introduced by the windowing process, which could slightly lag the real-time pressure changes.

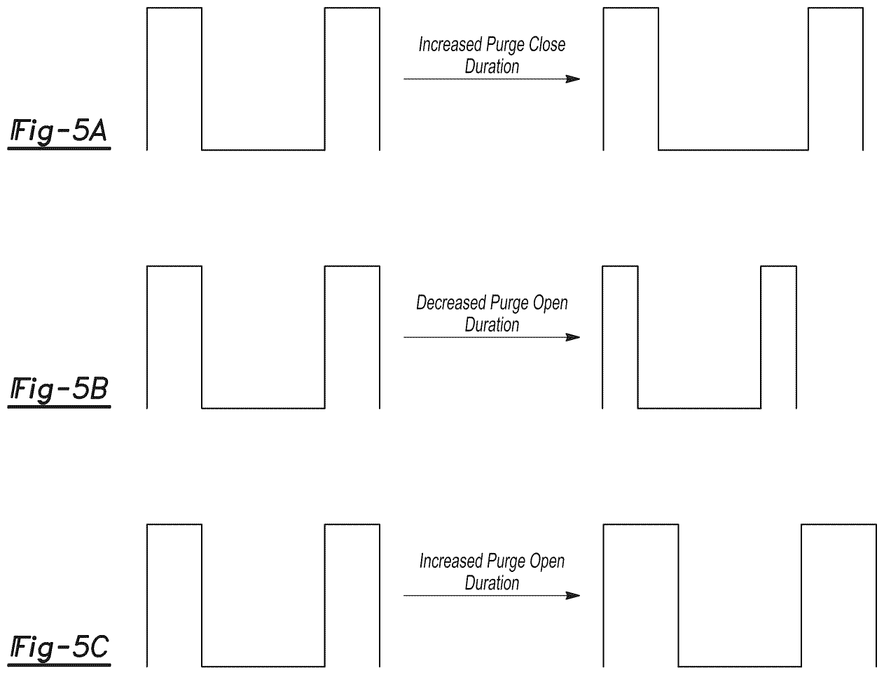

Referring to FIGS. 5A-5C, the purge close duration may be increased, the purge open duration may be decreased, and the purge open duration may be increased, respectively, based on the anode slope according to the algorithms described herein.

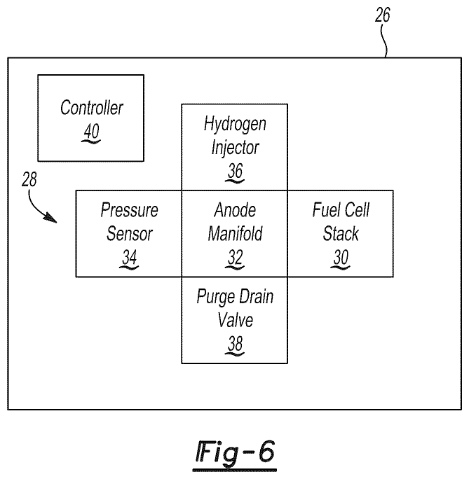

Referring to FIG. 6, a vehicle 26 is equipped with a fuel cell system 28 that plays a role in converting hydrogen into electrical energy. At the core of the system 28 is a fuel cell stack 30, where the electrochemical reactions occur to produce electricity. An anode manifold 32 is connected to the fuel cell stack 30 and is responsible for channeling hydrogen into the stack 30. A pressure sensor 34 is tasked with continuously monitoring the pressure within the anode manifold 32, providing real-time pressure data. A hydrogen injector 36 directly controls the injection of hydrogen into the anode manifold 32. A drain valve 38 serves a function by removing excess water and gases from the anode manifold 32.

Overseeing the operation is controller 40, which processes data from the pressure sensor 34 and manages the actions of the fuel cell stack 30, the hydrogen injector 36, the drain valve 38, etc. It may use automotive communication protocols such as CAN (Controller Area Network), LIN (Local Interconnect Network), and/or FlexRay to establish communication channels. The controller 40 implements the algorithms contemplated herein. By analyzing these pressure changes, the controller 40 can dynamically adjust the purge schedule and hydrogen injection patterns, adapting to changing conditions within the fuel cell system 28, such as aging components or variability in operating conditions.

To detect use in the field, the anode pressure signal and DV command can be intercepted and modified by, for example, placing a current probe on the DV actuator wire. To test the system, the fuel cell stack can be run in a steady state, maintaining consistent current and temperature, while the purge frequency is observed. A change in the anode pressure slope is then introduced, coinciding with the rising or falling edge of the purge command. If this intervention results in a change in purge frequency, it indicates that the algorithms contemplated herein are in use.

To implement this approach, a signal intervention box can be built or purchased. This box takes the output from the actual pressure sensor as input, interprets and modifies the signal, and then transmits it to the control module. When the fuel cell operates in a steady state, the command signal to the DV is measured. If the control module is using the algorithm described herein, it will increase the purge frequency and/or duration to evacuate the water.

If the pressure signal sent to the control module is modified such that the downward pressure slope decreases some time after DV opening and increases on the falling edge of the DV command, the control module will interpret this as an indication that all water has been successfully evacuated and the purge was adequate. As a result, the control module would reduce the purge frequency and/or duration. If the original signal is then restored, the control module would once again increase the purge frequency and/or duration. Other techniques could also be used to detect use in the field.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. “Controller” and “Controllers,” for example, can be used interchangeably herein as the functionality of one can be distributed across several, which may all communicate via standard techniques. “Drain valve” can also mean “purge drain valve” as some valves have integrated purge and drain functionality.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a fuel cell system including an anode manifold, a drain valve, and a controller programmed to alter a duration for which the drain valve remains closed according to an anode pressure slope associated with the anode manifold.

2. The vehicle of claim 1, wherein the controller is further programmed to increase the duration according to the anode pressure slope.

3. The vehicle of claim 2, wherein the controller is further programmed to increase the duration according to the anode pressure slope before and after an opening command for the drain valve.

4. The vehicle of claim 1, wherein the controller is further programmed to decrease the duration according to the anode pressure slope.

5. The vehicle of claim 4, wherein the controller is further programmed to decrease the duration according to the anode pressure slope before and after a closing command for the drain valve.

6. The vehicle of claim 1, wherein the controller is further programmed to increase a duration for which the drain valve remains open according to the anode pressure slope.

7. The vehicle of claim 5, wherein the controller is further programmed to increase the duration for which the drain valve remains open according to the anode pressure slope before and after a closing command for the drain valve.

8. The vehicle of claim 1, wherein the controller is further programmed to generate an alert based on a value of the duration.

9. A method comprising:
increasing a duration for which a drain valve of a fuel cell system remains closed responsive to a change in anode pressure slope associated with an opening command for the drain valve.

10. The method of claim 9 further comprising decreasing the duration responsive to a change in anode pressure slope associated with a closing command for the drain valve.

11. The method of claim 9 further comprising increasing a duration for which the drain valve remains open responsive to a change in anode pressure slope associated with a closing command for the drain valve.

12. A fuel cell system comprising:
a fuel cell stack;
a drain valve; and
a controller programmed to alter a duration for which the drain valve remains open based on a change in slope of anode pressure resulting from a closing command for the drain valve.

13. The fuel cell system of claim 12, wherein the controller is further programmed to increase the duration based on the change in slope.

14. The fuel cell system of claim 12, wherein the controller is further programmed to decrease a duration for which the drain valve remains closed based on the change in slope.

15. The fuel cell system of claim 12, wherein the controller is further programmed to alter a duration for which the drain valve remains closed based on a change in slope of anode pressure resulting from an opening command for the drain valve.

16. The fuel cell system of claim 15, wherein the controller is further programmed to increase the duration for which the drain valve remains closed based on the change in slope resulting from the opening command.
